(19) United States
(12) Patent Application Publication
(10) Pub. No.: US 2017/0335600 A1
(43) Pub. Date: Nov. 23, 2017

(54) Assemblable keys bearing meaningful composite indicia and methods of using the same

(71) Applicant: Ehud BOUSSO, Herzlia (IL)

(72) Inventor: Ehud BOUSSO, Herzlia (IL)

(21) Appl. No.: 15/598,295

(22) Filed: May 17, 2017

(30) Foreign Application Priority Data
May 18, 2016 (GB) 1608725.6

(51) Int. Cl. E05B 19/18; E05B 35/00; E05B 19/24

(52) U.S. Cl. CPC E05B 19/18; E05B 19/24; E05B 35/003

(57) ABSTRACT

A key bearing meaningful composite indicia including a plurality of assembleable key bits is described, where correctly selecting the assembleable key bits and properly combining them on the shaft of the key renders said key configured to achieve mechanical actuation of a compatible tumbler lock tract.

### CROSS REFERENCE TO RELATED APPLICATIONS

This application claims priority under the Paris Convention on United Kingdom (GB) Patent Application No. 1608725.6 filed on May 18, 2016, the entire content of which is herein incorporated by reference.

### TECHNICAL FIELD

In general, the present invention pertains to the art of mechanics. More particularly, the present invention, in some embodiments thereof, relates to an assemblable key bearing meaningful indicia on the bits thereof as well as to a method of using the same. The assemblable key bearing meaningful indicia thereon, in a non-limiting manner, is beneficially implementable as a game, quiz, instructing and/or learning aid or preferably as accessory in an escape/exit room.

### BACKGROUND OF THE INVENTION

It is believed that the current state of the art is represented by the following patent literature: U.S. Pat. No. 195,118, U.S. Pat. No. 1,022,900, U.S. Pat. No. 2,430,914, U.S. Pat. No. 2,440,429, U.S. Pat. No. 3,243,979, U.S. Pat. No. 6,823,702, U.S. Pat. No. 8,297,800, U.S. Pat. No. 6,604,308, U.S. Pat. No. 5,086,632, U.S. Pat. No. 8,794,043, U.S. Pat. No. 939,679, US2013298623, US2013291361, US2015361689, US2010199731 as well as CN102242583, CN2806679, WO2016026239, GB2217771, DE3228918 and DE3228918.

DE3228918 teaches a permutation cylinder lock with flat key, of which the web, during insertion into the lock, displaces the locking elements or tumblers of the lock from the blocking position into the open position. The key web in DE3228918 consists of individual segments of equal width which are lined up in succession on the key shank and which form web teeth. The segments in DE3228918 are releasably arranged on the key shank of the flat key divided in the longitudinal direction and are held positively and/or non-positively (for example, clamping between the shank halves, attachment onto projections of the key shank, insertion into grooves of the key shank). The segments in DE3228918 are exchangeable and can be adapted to a particular key secret.

WO2016026239 discloses a variable combined encrypted mechanical key free of shaft connection, including a key handle, where one end of the key handle is detachably connected to a key-shaped member formed by combining a plurality of independent key-shaped parts which are connected sequentially in a nested manner; axial connection between the end of the key handle and the adjacent key-shaped part and that between two adjacent key-shaped parts are achieved by virtue of a nested connection structure; and radial positioning between the end of the key handle and the adjacent key-shaped part and that between two adjacent key-shaped parts are achieved via positioning pins.

Escape rooms are a type of physical adventure game in which people are locked in a room with other participants and have to use elements of the room to solve a series of puzzles, find clues, and escape the room within a set time limit. The games are based on “escape the room” computer/video games in which the player is locked inside a room and must explore their surroundings in order to escape. Players must be observant and use their critical thinking skills to escape the room. Weekend or day event escape games have been held in the United States, Europe, Australia, and a number of Asian countries. In the 2010s, escape rooms became popular in the United States, Japan, Taiwan, Canada and mainland China.

### Definitions

The terms pin tumbler or a tumbler lock, colloquially also known as Yale lock, as referred to herein should be construed as any type of a lock mechanism that uses pins of varying lengths to prevent the lock from opening without the correct key and inter alia as set forth in: Pin tumbler lock Wikipedia https://en.wikipedia.org/w/index.php?title=Pin_tumbler_lock&oldid=715 757816

Pin tumbler locks are most commonly employed in cylinder locks. In this type of lock, an outer casing has a cylindrical hole in which the plug is housed. To open the lock, the plug must rotate. The plug has a straight-shaped slot known as the keyway at one end to allow the key to enter the plug; the other end may have a cam or lever, which activates a mechanism to retract a locking bolt. The keyway often has protruding ledges that serve to prevent the key pins from falling into the plug, and to make the lock more resistant to picking. A series of holes, typically five or six of them, are drilled vertically into the plug. These holes contain key pins of various lengths, which are rounded to permit the key to slide over them easily. Above each key pin is a corresponding set of driver pins, which are spring-loaded.

Simpler locks typically have only one driver pin for each key pin, but locks requiring multi-keyed entry, such as a group of locks having a master key, may have extra driver pins known as spacer pins. The outer casing has several vertical shafts, which hold the spring-loaded pins. When the plug and outer casing are assembled, the pins are pushed down into the plug by the springs. The point where the plug and cylinder meet is called the shear point. With a key properly cut and inserted into the groove on the end of the plug, the pins will rise causing them to align exactly at the shear point. This allows the plug to rotate, thus opening the lock. When the key is not in the lock, the pins straddle the shear point, preventing the plug from rotating.

The term indicia as referred to herein should be defined broadly to include anything that provides a visible indication in one or more types of light. Indeed, the invention is intended to embrace all modifications and variations which fall within the broadest scope of the recognized dictionary definition of term indicia, inter alia including one or a plurality of marks, demarcations, points, letters, numbers, icons or cues.

The term Escape room as referred to herein should be construed in a non-limiting manner as described at: Escape room Wikipedia https://en.wikipedia.org/wiki/Escape_room

### SUMMARY OF THE INVENTION

A key bearing meaningful composite indicia including a plurality of assembleable key bits is described, where correctly selecting the assembleable key bits and properly combining them on the shaft of the key renders said key configured to achieve mechanical actuation of a compatible tumbler lock.

### BRIEF DESCRIPTION OF THE DRAWINGS

The present invention will be understood and appreciated more comprehensively from the following detailed description taken in conjunction with the appended drawings in which:

FIG. 1A is a schematic isometric view of a key with shaft, in accordance with one embodiment of the present invention;

FIG. 1B is a schematic cross-sectional view taken along B-B cross-sectional line of the key with shaft, shown in FIG. 1A;

FIG. 2A to 2E are schematic isometric views of assembleable key bits, bearing individual indicia constituents thereon, in accordance with one embodiment of the present invention;

FIG. 3 is a schematic side view of an assembly, comprising the key with shaft shown in FIG. 1A and assembleable key bits shown in FIG. 2A to 2E, arranged to form composite meaningful indicia from individual indicia constituents, in accordance with one embodiment of the present invention;

FIG. 4 is a schematic isometric view of a key with shaft, in accordance with another embodiment of the present invention;

FIG. 5A to 5E are schematic isometric views of assembleable key bits, bearing individual indicia constituents thereon, in accordance with another embodiment of the present invention;

FIG. 6 is a schematic perspective view of an assembly, comprising the key with shaft shown in FIG. 4 and assembleable key bits shown in FIG. 5A to 5E, arranged to form composite meaningful indicia from individual indicia constituents, in accordance with another embodiment of the present invention.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DESCRIPTION OF THE INVENTION

Illustrative embodiments of the invention are described below. In the interest of clarity, not all features of actual implementation are described in this specification. It will of course be appreciated that in the development of any such actual embodiment, numerous implementation-specific decisions must be made to achieve the developers' specific goals, such as compliance with technology- or business-related constraints, which may vary from one implementation to another. Moreover, it will be appreciated that the effort of such a development might be complex and time-consuming, but would nevertheless be a routine undertaking for those of ordinary skill in the art having the benefit of this disclosure.

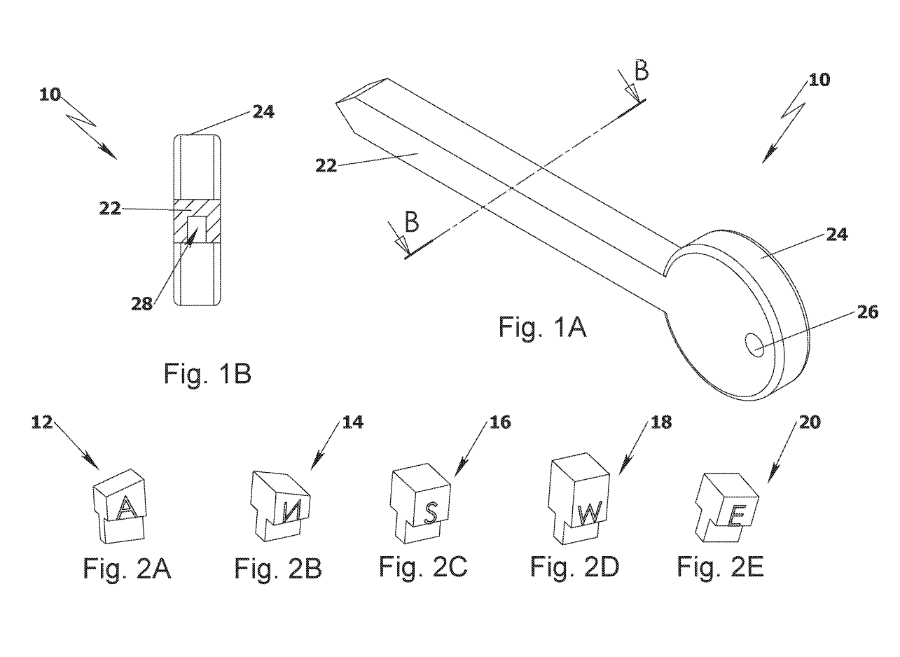

In accordance with some embodiments of the present invention, reference is now made to FIG. 1A to 3. FIGS. 1A and 1B show one embodiment of key 10 comprising shaft 22 and grip handle 24, in accordance with of the present invention. Grip handle 24 optionally comprises tab 26 as well as other structural and/or ornamental elements (not shown). In some embodiments grip handle 24 bears part of the composite meaningful indicia (not shown) and/or a hint/lead or question (not shown) related to the meaningful composite indicia, as will be further elaborated infra.

Key 10 with shaft 22 is configured to operate with a compatible tumbler lock (not shown) comprising an outer casing with a cylindrical hole and the plug with a keyway and series of holes containing key pins and a corresponding spring-loaded driver pin in the outer casing above each key pin in the plug. The compatible tumbler lock (not shown) in accordance with the present invention is preferably promptly programmable, entailing physical accessibility and ability to exchange the aforesaid key pins in the plug and/or corresponding spring-loaded driver pin in the outer casing.

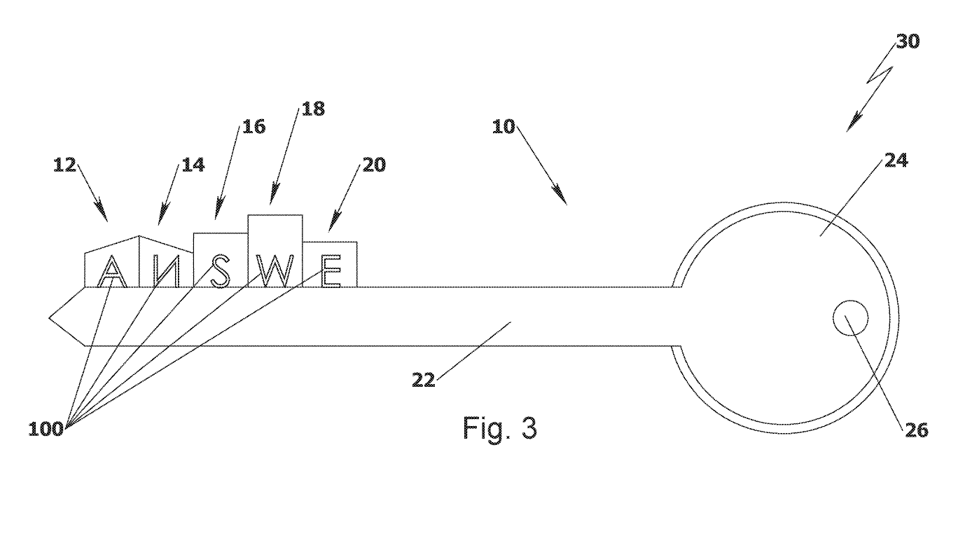

Shaft 22 of key 10 embodies inferior essentially U-shaped groove 28, extending along the longitudinal centerline on the bottom face of shaft 22. Inferior groove 28 is configured to receive the protruding portion of assembleable key bits 12 to 20, shown in FIG. 2A to 2E.

Assembleable key bits 12 to 20, shown in FIG. 2A to 2E, embody particular and distinct shapes, forms, heights or sizes configured to respectively match and thereupon operate the key pins (not shown) in the plug (not shown) and consequently the corresponding spring-loaded driver pin (not shown) in the outer casing (not shown) of a compatible tumbler lock (not shown). Additionally to the particular and distinct shape, form, height or size configured to match and operate the key pins (not shown) in the plug (not shown) of a compatible tumbler lock (not shown), assembleable key bits shown in FIG. 2A to 2E bear individual indicia constituents thereon. Thus for instance assembleable key bit 12 shown in FIG. 2A bears an indicium of the Latin letter A, assembleable key bit 14 shown in FIG. 2B bears an indicium of the Latin letter N, assembleable key bit 16 shown in FIG. 2C bears an indicium of the Latin letter S, assembleable key bit 18 shown in FIG. 2D bears an indicium of the Latin letter W, whereas assembleable key bit 20 shown in FIG. 2E bears an indicium of the Latin letter E, etc.

Assembleable key bits 12 to 20, shown in FIG. 2A to 2E, embody a protruding bottom portion, configured to be received into inferior groove 28 in shaft 22 of key 10. Protruding bottom portion of assembleable key bits 12 to 20, shown in FIG. 2A to 2E, are further configured to be affixed within inferior groove 28 on shaft 22 of key 10. The mechanism affixing assembleable key bits 12 to 20, shown in FIG. 2A to 2E, within inferior groove 28 on shaft 22 of key 10, in a non-limiting manner employs magnetic, frictional and/or mechanic means, such as detents, to achieve the removable affixability of assembleable key bits 12 to 20 in groove 28 on shaft 22.

As previously mentioned, assembleable key bits shown in FIG. 2A to 2E, bear individual indicia constituents thereon. Each indicium constituent is meaningless, in the sense that each indicium constituent being just a letter, syllable, sign, mark or a part of the entire composite meaningful indicia, shown in a partially composed form in FIG. 3. Similarly, each assembleable key bit is incapable to achieve the mechanical actuation of the compatible tumbler lock (not shown). Only upon correct selection of the right assembleable key bits, from a set comprising a plurality of other assembleable key bits, and proper combination thereof on shaft 22 of key 10, the entire composite meaningful indicia 100, shown in a partially composed form in FIG. 3, is composed so that key 10 is capable to achieve the mechanical actuation of the compatible tumbler lock (not shown).

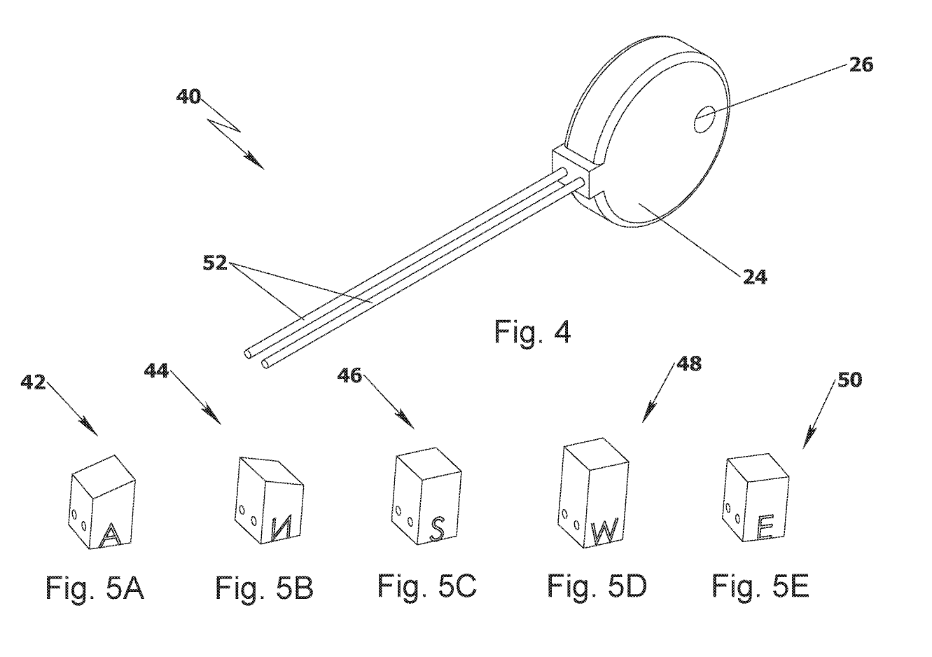

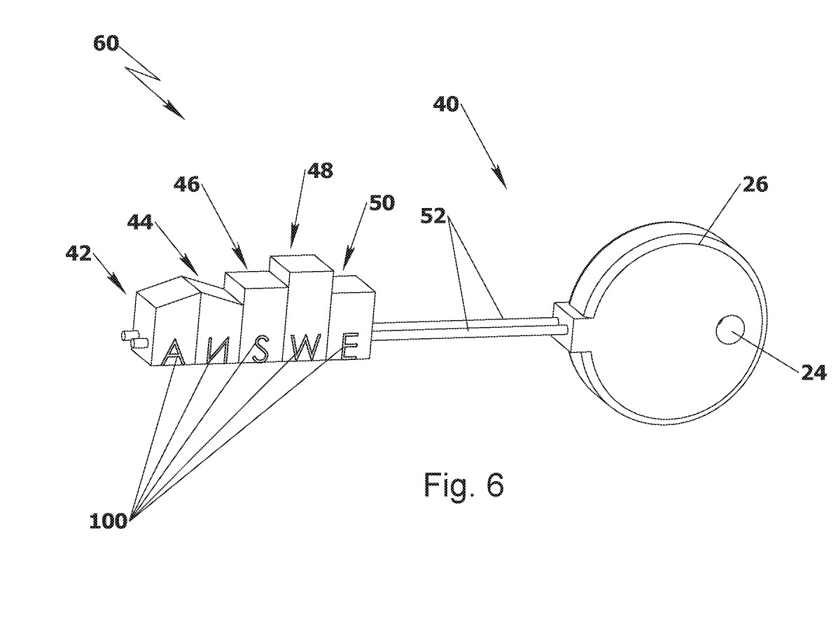

In accordance with another embodiment of the present invention, reference is now made to FIG. 4 to 6. FIG. 4 shows another embodiment of key 40 comprising shaft 52 and grip handle 24. Grip handle 24 optionally comprises tab 26 as well as other structural and/or ornamental elements (not shown).

Shaft 52 of key 40 embodies a pair of parallel cylindrical rods, configured to operate with a compatible tumbler lock (not shown). Parallel cylindrical rods of shaft 52 are configured to be threaded into assembleable key bits 42 to 50, shown in FIG. 5A to 5E.

Assembleable key bits 42 to 50, shown in FIG. 5A to 5E, embody particular and distinct shapes, forms, heights or sizes configured to respectively match and thereupon operate a compatible tumbler lock (not shown) and bear individual indicia constituents thereon; key bit 42 an indicium A, assembleable key bit 44 bears an indicium N, assembleable key bit 46 bears an indicium S, assembleable key bit 48 bears an indicium W, whereas assembleable key bit 50 bears an E.

Only upon correct selection of the right assembleable key bits, from a set comprising a plurality of other assembleable key bits, and proper combination thereof on shaft 52 of key 40, the entire composite meaningful indicia 100, shown in a partially composed form in FIG. 3, is composed so that key 40 is capable to achieve the mechanical actuation of the compatible tumbler lock (not shown).

In some embodiments the shaft of the key configured to operate the compatible tumbler lock (not shown), such as shaft 22 shown in FIG. 1 or shaft 22 shown in FIG. 4, bears part of the composite meaningful indicia (not shown) and/or a hint/lead or question (not shown) related to the meaningful composite indicia.

In one embodiment the key configured to operate the compatible tumbler lock (not shown) is shaft-less, comprising essentially a handle, while the assembleable key bits comprising an interlocking mechanism, so that the construction of the key is segmental. In such embodiments the shaft of the assembleable key is formed by segmentally connecting assembleable key bits in tandem.

It will be appreciated by persons skilled in the art that the present invention is not limited by what has been particularly shown and described herein above. Rather the scope of the invention is defined by the claims which follow:

What is claimed is:

1. An assemblable key bearing meaningful composite indicia comprises:
(a) a handle;
(b) at least one structural element on said handle, configured for engagement with assembleable key bits, thereby forming a key shaft;
(c) a plurality of said assembleable key bits, wherein each one of said assembleable key bits comprising:
(i) at least one structural element configured for engagement with said shaft;
(ii) a unique shape or size;
(iii) an indicium constituent;
wherein upon correct selection of said assembleable key bits and proper combination of said assembleable key bits on said shaft of said key, entire composite meaningful indicia are composed; and
wherein upon correct selection of said assembleable key bits and proper combination of said assembleable key bits on said shaft, said key is configured to achieve mechanical actuation of a compatible pin tumbler lock.

2. The assemblable key bearing meaningful composite indicia, as set forth in claim 1, wherein said shaft further comprises a groove, configured to receive said assembleable key bits.

3. The assemblable key bearing meaningful composite indicia, as set forth in claim 1, wherein said shaft comprises a pair of parallel rods configured to be threaded into said assembleable key bits.

4. The assemblable key bearing meaningful composite indicia, as set forth in claim 1, wherein said assembleable key bits comprise an interlocking mechanism and wherein said shaft is formed by segmentally connecting said assembleable key bits in tandem.

5. The assemblable key bearing meaningful composite indicia, as set forth in claim 1, further comprises a mechanism configured for affixing said assembleable key bits to said shaft, comprising at least one means selected from the group consisting of: a magnetic means, a frictional means, a mechanical means and detent.

6. The assemblable key bearing meaningful composite indicia, as set forth in claim 1, in combination with said compatible pin tumbler lock.

7. The assemblable key bearing meaningful composite indicia, as set forth in claim 1, in combination with said compatible pin tumbler lock, wherein said compatible pin tumbler lock is programmable, thereby providing for changing said composite meaningful indicia.

8. The assemblable key bearing meaningful composite indicia, as set forth in claim 1, wherein at least one member selected from the group consisting of: said handle and said shaft, comprises at least one member selected from the group consisting of: a part of said composite meaningful indicia, hint/lead indicia related to said composite meaningful indicia and question indicia related to said composite meaningful indicia.

9. A method of assembling a key bearing meaningful composite indicia comprises:
(a) providing said key comprising:
(i) a handle;
(ii) a shaft extending on said handle, wherein said shaft comprises at least one structural element configured for engagement with assembleable key bits;
(b) providing a plurality of said assembleable key bits, wherein each one of said assembleable key bits comprising:
(i) at least one structural element configured for engagement with said shaft;
(ii) a unique shape or size;
(iii) an indicium constituent;
(c) correctly selecting said assembleable key bits and properly combining said assembleable key bits on said shaft of said key, thereby composing entire meaningful indicia; and
(d) correctly selecting said assembleable key bits and properly combining said assembleable key bits on said shaft of said key, thereby rendering said key configured to achieve mechanical actuation of a compatible pin tumbler lock.

10. The method of assembling a key bearing meaningful composite indicia, as set forth in claim 9, further comprises mechanically actuating said compatible pin tumbler lock.

11. The method of assembling a key bearing meaningful composite indicia, as set forth in claim 9, wherein said meaningful composite indicia is an answer or solution in a game or quiz.

12. The method of assembling a key bearing meaningful composite indicia, as set forth in claim 9, wherein at least one member selected from the group consisting of: said handle and said shaft, comprises at least one member selected from the group consisting of: a part of said composite meaningful indicia, hint/lead related to said composite meaningful indicia and question related to said composite meaningful indicia.

13. A kit-of-parts for assembling a key bearing meaningful composite indicia comprises:
(a) said key comprising:
(i) a handle;
(ii) at least one structural element on said handle, configured for engagement with assembleable key bits, thereby forming a key shaft;
(b) a plurality of said assembleable key bits, wherein each one of said assembleable key bits comprising:
(i) at least one structural element configured for engagement with said shaft;
(ii) a unique shape or size;
(iii) an indicium constituent;
wherein upon correctly selecting said assembleable key bits and properly combining said assembleable key bits on said shaft of said key, thereby composing entire meaningful indicia; and
wherein upon correctly selecting said assembleable key bits and properly combining said assembleable key bits on said shaft of said key, thereby rendering said key configured to achieve mechanical actuation of a compatible pin tumbler lock.

14. The kit-of-parts as set forth in claim 13, wherein said shaft further comprises a groove, configured to receive said assembleable key bits.

15. The kit-of-parts as set forth in claim 13, wherein said shaft comprises a pair of parallel rods configured to be threaded into said assembleable key bits.

16. The kit-of-parts as set forth in claim 13, wherein said assembleable key bits comprise an interlocking mechanism and wherein said shaft is formed by segmentally connecting said assembleable key bits in tandem.

17. The kit-of-parts as set forth in claim 13, further comprises a mechanism configured for affixing said assembleable key bits to said shaft, comprising at least one means selected from the group consisting of: a magnetic means, a frictional means, a mechanical means and detent.

18. The kit-of-parts as set forth in claim 13, in combination with said compatible pin tumbler lock.

19. The kit-of-parts as set forth in claim 13, in combination with said compatible pin tumbler lock, wherein said compatible pin tumbler lock is programmable, thereby providing for changing said composite meaningful indicia.

20. The kit-of-parts as set forth in claim 13, wherein at least one member selected from the group consisting of: said handle said shaft, further comprises at least one member selected from the group consisting of: a part of said composite meaningful indicia, hint/lead indicia related to said composite meaningful indicia and question indicia related to said composite meaningful indicia.
